(19) United States
(12) Patent Application Publication
(10) Pub. No.: US 2011/0216898 A1
(43) Pub. Date: Sep. 8, 2011

(54) TELEPHONE HAVING ROTATABLE HOOK TO SUPPORT HANDSET

(75) Inventors: JIA-NING HUANG, Shenzhen City (CN); MENG-HUA HE, Shenzhen City (CN); GANG CHENG, Shenzhen City (CN); RUI LIU, Shenzhen City (CN); CHUN-CHE YEN, Tu-Cheng (TW); YU-TAO CHEN, Tu-Cheng (TW); TE-SHENG JAN, Tu-Cheng (TW)

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/823,324

(22) Filed: Jun. 25, 2010

(30) Foreign Application Priority Data
Mar. 2, 2010 (CN) 201010116052.7

(51) Int. Cl. H04M 1/00

(52) U.S. Cl. 379/428.02

(57) ABSTRACT

A telephone includes a handset, a base and a hook. The handset includes a earpiece defining a slot. The base defines a first recess and an opening. The first recess is configured for receiving the earpiece. The opening includes a second recess and a through hole defined in a bottom of the second recess. The hook includes a head and an elastic rod protruding from the head. The rod is rotatably received in the through hole. The head is received in the second recess and able to rotate and insert into the slot for supporting the handset.

### BACKGROUND

1. Technical Field

The present disclosure relates to telephones, especially to a telephone with a rotatable hook to support a handset.

2. Description of Related Art

A telephone often includes a base and a handset. A telephone can be placed horizontally on a desk or mounted vertically on a wall. Generally, the base defines a recess to receive the earpiece. A hook mounted on the sidewall of the recess is received in a receiving hole in the earpiece to support the handset when the telephone is vertical. When the telephone is placed on a desk, the hook can be detached from the base. The detaching of the hook is often troublesome.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded view of a telephone according to an exemplary embodiment.

FIG. 2 is a partial isometric view showing a base of the telephone of FIG. 1, with certain elements omitted for clarity.

FIG. 3 is an isometric view of a hook of the telephone in FIG. 1.

FIG. 4 shows the telephone of FIG. 1 in a horizontal orientation.

FIG. 5 is partial, cross-sectional view of the telephone in FIG. 4, taken along line V-V of FIG. 1.

FIG. 6 shows the telephone of FIG. 1 in a vertical orientation.

FIG. 7 is partial, cross-sectional view of the telephone in FIG. 6, taken along line VII-VII of FIG. 6.

### DETAILED DESCRIPTION

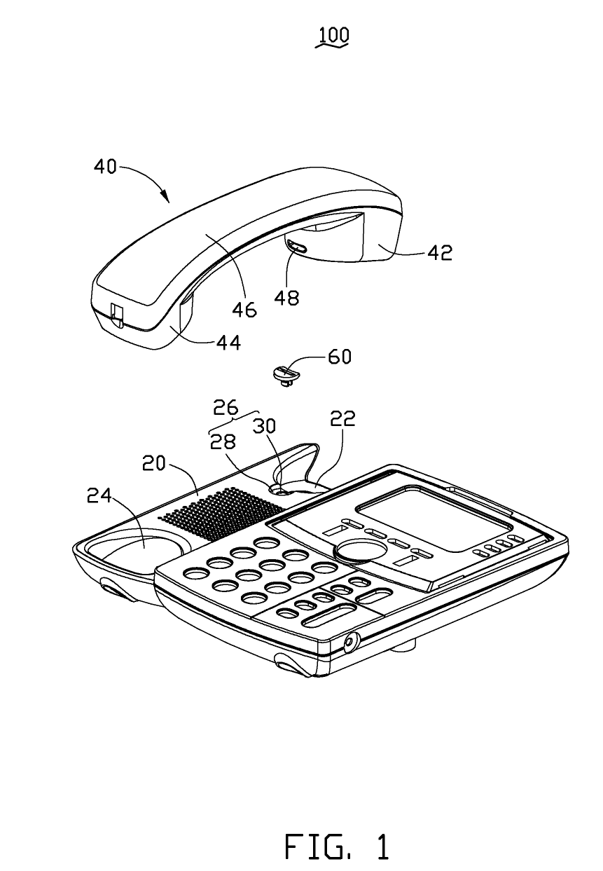

Referring to FIG. 1, a telephone 100 according to an exemplary embodiment includes a base 20, a handset 40, and a hook 60. The handset 40 includes an earpiece 42, a mouthpiece 44, and a handle 46 connecting the earpiece 42 to the mouthpiece 44. The earpiece 42 defines a slot 48 in a surface opposite to the mouthpiece 44. The base 20 defines a first recess 22 and a second recess 24, to partially receive the earpiece 42 and the mouthpiece 44, respectively. The base 20 further defines an opening 26. The hook 60 is rotatably installed in the opening 26 and can fit into the slot 48 to support the handset 40, when the telephone 100 is hung on a wall.

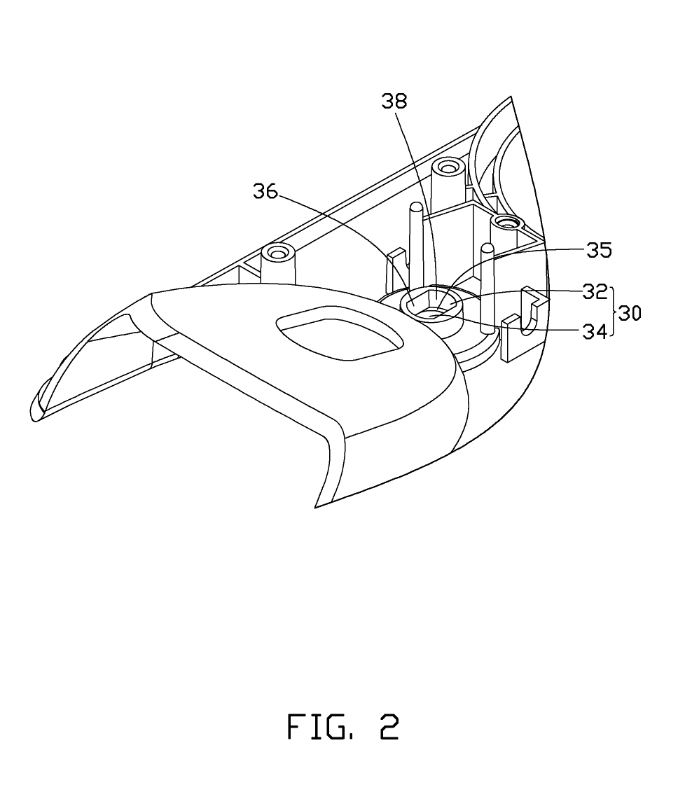

The opening 26 includes a third recess 28 communicating with the first recess 22, and a through hole 30 defined in a bottom of the recess 28. Referring also to FIG. 2, the through hole 30 is a stepped hole that includes a smaller hole 32 aligned with the recess 28, and a larger hole 34 communicating with the smaller hole 32. The larger hole 34 includes two opposite surfaces 36 and two arcuate surfaces 38 connecting the two surfaces 36. The distance between two arcuate surfaces 38 is greater than the size of the smaller hole 32, thereby forming a step 35.

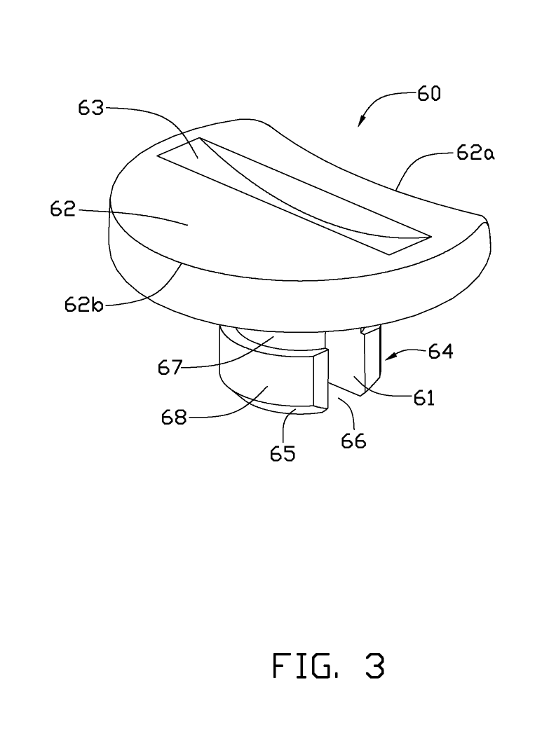

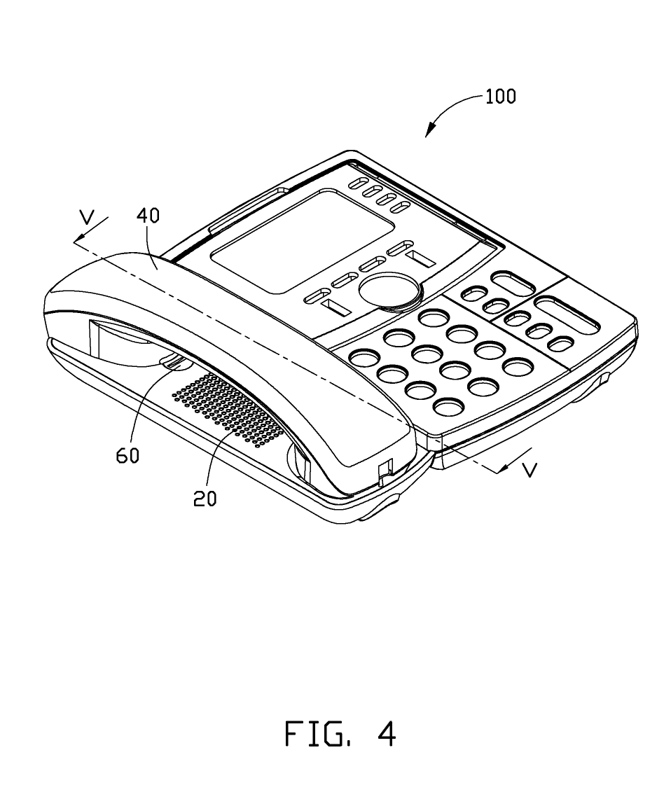

Referring to FIGS. 3, 4 and 5, the hook 60 is made of elastic material, including a semicircular-shaped head 62 and a rod 64 protruding from the head 62. The rod 64 defines a slot 66 extending through its lateral surface, forming two spring tabs 61. The rod 64 also defines an annular groove 67 around its lateral surface, forming two shoulders 68. The rod 64 also includes an angled end 65 for ease of inserting into the hole 32. The head 62 includes a first end 62a and a second end 62b opposite to the first end 62a. The distance between the second end 62b and the adjacent spring tab 61 is greater than the distance between the first end 62a and the adjacent spring tab 61. The head 62 defines a slot 63 for use with an auxiliary tool such as a screwdriver to rotate the head 62.

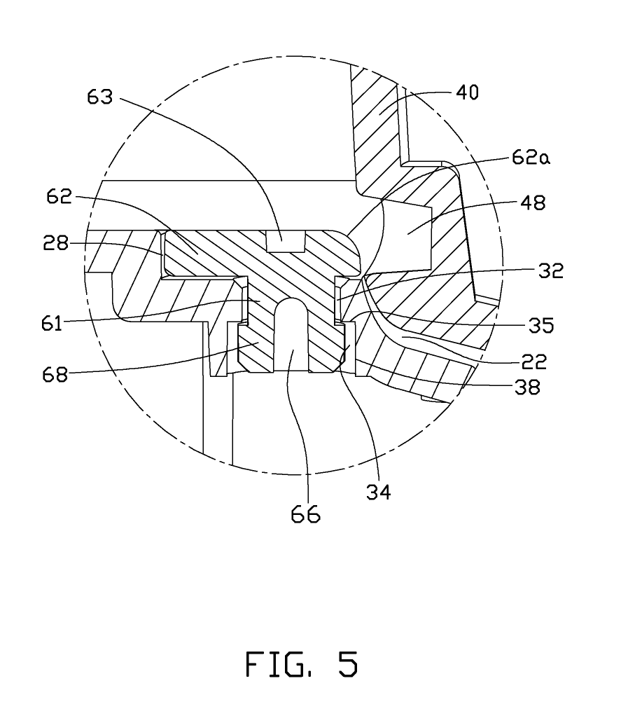

When connecting the hook 60 to the base 20, the rod 64 is first inserted into the hole 32. During the insertion, because the rod 64 is wider than the hole 32, the spring tabs 61 are elastically deflected until the shoulders 68 are received within the hole 34, which snap-connects the hook 60 to the base 20. When the hook 60 is in a first position as shown in FIG. 5, a first end 62a of the head 62 is aligned with an edge of the recess 22.

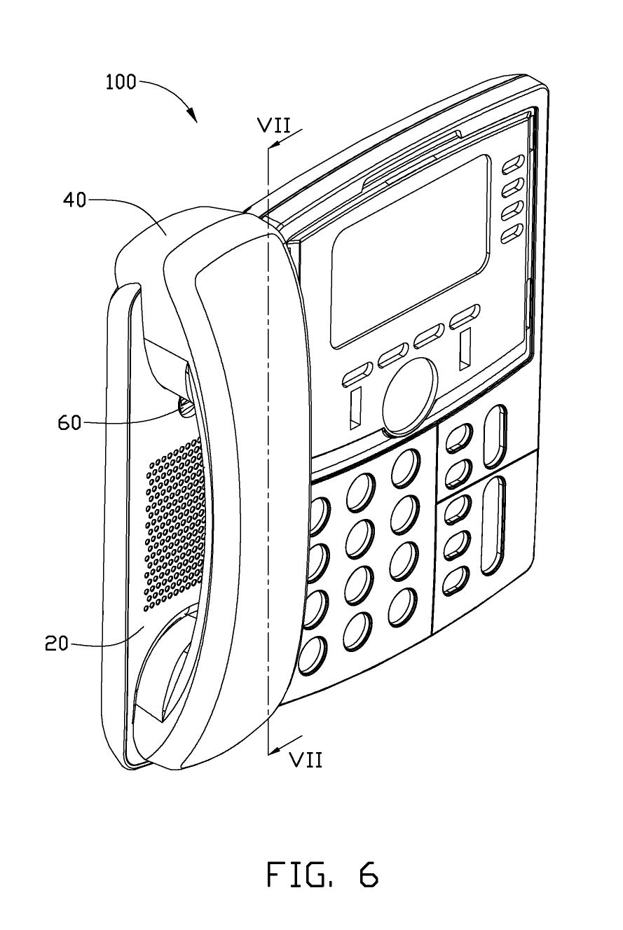

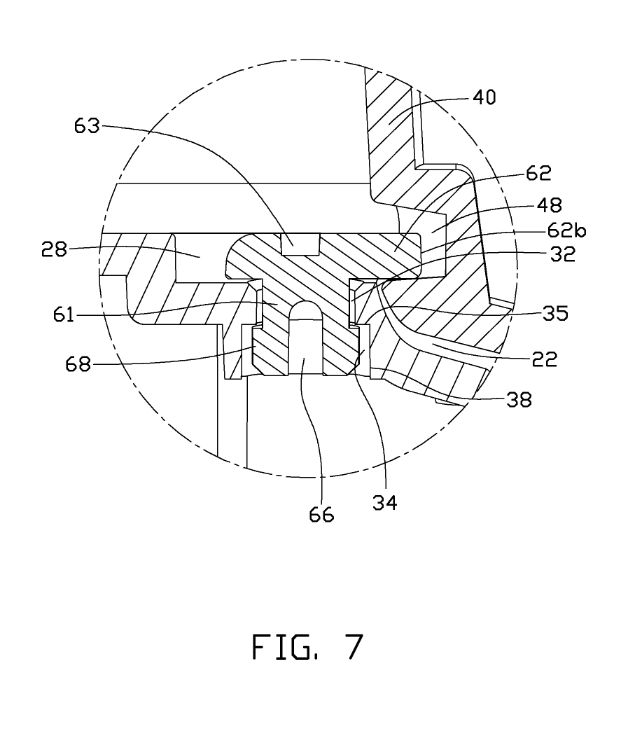

Referring to FIGS. 6 and 7, when needing to mount the telephone 100 on a wall, the head 62 is rotated to cause its second end 62b to protrude out of the edge of the recess 22. The handset 40 can thus be placed on the base 20 with the earpiece 42 supported by the second end 62b received in the slot 48.

It is to be understood, however, that even though numerous characteristics and advantages of the present disclosure have been set forth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A telephone comprising:
a handset comprising a earpiece, the earpiece defining a slot;
a base defining a first recess and an opening, the first recess being configured for receiving the earpiece, the opening comprising a second recess and a through hole defined in a bottom of the second recess; and
a hook comprising a head and an elastic rod protruding from the head, the rod being rotatably received in the through hole, the head being received in the second recess and able to rotate to fit into the slot for supporting the handset.

2. The telephone of claim 1, wherein the rod defines a slot extending through its lateral surface, forming two spring tabs.

3. The telephone of claim 1, wherein the through hole comprise a smaller hole aligned with the second recess and a larger hole communicating with smaller hole, the rod also defines an annular groove around its lateral surface and forms two shoulders, the shoulders are received within the larger hole.

4. The telephone of claim 1, wherein the rod also includes an angled end.

5. The telephone of claim 2, wherein the head includes a first end and a second end opposite to the first end, the distance between the second end and the adjacent spring tab is bigger than the distance between the first end and the adjacent spring tab, the second end is configured for being inserted into the slot.

6. The telephone of claim 1, wherein the second recess communicates with the first recess.
